(19) United States
(12) Patent Application Publication
(10) Pub. No.: US 2026/0106683 A1
(43) Pub. Date: Apr. 16, 2026

(54) SYSTEMS, APPARATUSES AND METHODS TO DISTRIBUTE TIMESTAMPS IN A WIRELESS NETWORK

(71) Applicant: Huawei Technologies Co., Ltd., Shenzhen (CN)

(72) Inventor: Michael George Mayer, Ottawa (CA)

(21) Appl. No.: 19/409,182

(22) Filed: Dec. 4, 2025

Related U.S. Application Data
(63) Continuation of application No. PCT/CN2023/114260, filed on Aug. 22, 2023.

(51) Int. Cl. H04J 3/06; H04W 56/00; H04W 80/06; H04W 84/06

(52) U.S. Cl. CPC H04J 3/0673; H04W 56/004; H04W 80/06; H04W 84/06

(57) ABSTRACT

A method and apparatus for synchronizing a clock at a terrestrial network node with a reference clock at a non-terrestrial node (NTN) is provided. The method includes, at the NTN, obtaining a timestamp value based on the reference clock and adjusting the timestamp value to an expected value that matches the time at which a message carrying the timestamp is expected to be transmitted to the terrestrial node. The timestamp adjustment accounts for the delay at each encapsulation action required to form the message. The timestamp adjustment value may also account for the time-of-flight for the message transmitted at the NTN to be received at the terrestrial node.

### CROSS-REFERENCE TO RELATED APPLICATION

This application is a continuation of International Patent Application No. PCT/CN2023/114260, filed Aug. 22, 2023, the contents of which are incorporated herein by reference in its entirety.

### TECHNICAL FIELD

The present disclosure pertains generally to network clock synchronization, and in particular to methods, apparatuses and systems for synchronizing clocks over a satellite network communication channel.

### BACKGROUND

Time distribution is expected to become increasingly important in Industrial Internet of Things (IIoT) technology where wireless communication networks are used to remotely support industrial processes that require actions to be performed in correct sequences. In particular, such methods and systems could be used to ensure that highly accurate time is distributed among the different devices performing the industrial processes. Financial transactions are another area where distribution of accurate time is needed, e.g., according to the regulations of the Markets in Financial Instrument Directive (MiFID), stock trades must be time-stamped. In either case, an example communication channel for distributing accurate time stamps is the New Radio (NR) channel defined by the 3GPP (3^{rd} Generation Partnership Project) standards for 5G wireless service.

Prior art solutions to time distribution can be grouped into three main areas: (1) use of a dedicated system, (2) use of the traffic signal and (3) use of a dedicated message exchange mechanism.

While the prior art solutions can distribute timestamps, the accuracy of the distributed timestamps can vary. This can limit the error of a received timestamp to a certain degree, but the error is dependent on the distance between the target clock and the source clock such as a radio node (e.g., gNB).

Therefore, there is a need for time distribution methods having the ability to wirelessly provide time with greater accuracy, and/or a reduced error, as well as systems to implement such methods, and such methods and systems would obviate or mitigate limitations of the prior art.

### SUMMARY

In a first aspect, the present disclosure provides a method that takes place at a non-terrestrial node (NTN) comprised in a communication network that also comprises a terrestrial node (TN), which includes a TN clock. The method comprises obtaining an original timestamp based on a reference clock. The method also includes generating a timestamp-carrying message (TCM) that includes a corrected timestamp by performing a plurality of processing actions having associated thereto a plurality of delay adjustment values (DAVs), which may also be referred to as processing delay values. Each processing action of the plurality of processing actions is associated with a respective DAV of the plurality DAVs. The plurality of processing actions include computing a sum of the plurality of DAVs to obtain a total DAV and adding the total DAV to the original timestamp to obtain the corrected timestamp. The method further includes encapsulating the corrected timestamp to form the TCM and transmitting the TCM to the TN for an adjustment of a TN clock time by the TN clock in accordance with the corrected timestamp. In some implementations, the reference clock may be part of the NTN.

In some implementations of the first aspect, the TCM is a first message, the corrected timestamp is a first timestamp, and the first message is received at the TN at a time on the target clock that has a corresponding second timestamp. The method of the first aspect may further comprise, at the NTN: receiving, from the TN, a second message transmitted to the NTN at a time at the target clock that has a corresponding third timestamp. The second message is received at the NTN at a time on the reference clock that has a corresponding fourth timestamp. The method may further include transmitting, to the TN, a third message containing the fourth timestamp. The TN may be configured to calculate based on the first timestamp, the second timestamp, the third timestamp and the fourth timestamp: an offset of the TN clock with respect to a time at the NTN; and a propagation delay (which may also be referred to as the time-of-flight) for a message transmitted from the NTN to reach the TN. The TN node may be further configured to correct the time on the target clock according to the offset and the propagation delay.

In some implementations of the first aspect, at least one DAV of the plurality of DAVs is based on at least one predicted DAV. The at least one DAV of the plurality of DAVs may have associated thereto at least one statistical distribution; and each at least predicted DAV may include at least one statistical parameter of a respective one of the at least one statistical distribution. The at least one statistical parameter may include at least one of an expected value, a median value, an average value, and a maximum value.

In some implementations of the first aspect, the NTN includes resources to perform the plurality of processing actions; and at least one DAV of the plurality of DAVs is based on a demand on the resources for performing the respective at least one processing action of the plurality of processing actions. The demand on the resources may have associated thereto a schedule scheduling when an individual processing action is to be performed by the resources and at least one of the at least one DAV depends on the schedule.

In some implementations of the first aspect, the method may further comprise obtaining a position of the NTN relative to the TN; determining, in accordance with the position of the NTN relative to the TN, a time-of-flight delay value for the TCM to reach the TN; and adding the time-of-flight delay value to the total DAV to obtain the corrected timestamp. In some implementations, the method may also comprise obtaining a frequency shift associated with a Doppler effect caused by a relative speed between the NTN and the TN; obtaining, in accordance with the frequency shift and the time-of-flight delay, a Doppler DAV; and adding the Doppler DAV to the total DAV to obtain the adjusted timestamp.

In some implementations of the first aspect, the method may further comprise obtaining the plurality of DAVs; and performing each of the plurality of processing actions within a respective time period defined by a respective DAV of the plurality of DAVs.

In some implementations of the first aspect, the plurality of processing actions may include user datagram protocol (UDP) actions configured to form a UDP packet comprising the corrected timestamp value. The plurality of processing actions may further include forming a packet data convergence protocol (PDCP) packet comprising the UDP packet. The plurality of processing action may further include forming a radio link control (RLC) packet comprising the PDCP packet. The plurality of processing action may further include forming a medium access control (MAC) packet comprising the RLC packet. The plurality of processing action may further include forming a physical (PHY) packet comprising the MAC packet.

In some implementations of the first aspect, obtaining the position of the NTN relative to the TN includes obtaining the position based on a predetermined position at an initial time, on a predetermined position rate of change as a function of time, and on a time period passed since the initial time.

In some implementations of the first aspect, the communication network comprises a plurality of nodes, including the TN; resources configured to perform the method are also configured to process and transmit other messages from the NTN to any node of the plurality of nodes; the resource usage data includes, for at least one message of the other messages, at least one of: a bit rate, a symbol duration, a number of bits per symbol, and a modulation format.

In a second aspect, the present disclosure provides, at a terrestrial node (TN) that has a target clock and that is part of a communication network that also has a non-terrestrial node (NTN) that is coupled to a reference clock, a method that comprises receiving, from the NTN, a timestamp-carrying message (TCM) generated at the NTN. The TCM comprises an adjusted timestamp. The NTN is configured to generate the TCM by performing a plurality of processing actions PAs having associated thereto a plurality of processing delay values (PDVs). Each PA of the plurality of PAs is associated with a PDV of the plurality PDVs. The plurality of PAs includes computing a sum of the plurality of PDVs to obtain a total PDV; adding the total PDV to an original timestamp to obtain the adjusted timestamp, wherein the original timestamp is obtained based on the reference clock; and encapsulating the adjusted timestamp to form the TCM. The method further comprises, at the TN, de-encapsulating the TCM to obtain the adjusted timestamp, the adjusted timestamp being a time T1; transmitting, at a time T3, a TN message to the NTN; receiving, from the NTN, at a time T4, wherein the time T4 is the time at which the TN message is received at the NTN; and in accordance with the time T1, the time T2, the time T3 and the time T4, adjusting the target clock.

In a third aspect, the present disclosure provides a method of synchronizing a target clock located at a node of a communication network with a reference clock coupled to a non-terrestrial node (NTN). The method comprises, at the NTN: obtaining a first timestamp value from the reference clock and calculating a first delay value (DV) in accordance with individual first processing delay values associated with respective individual processing actions to be performed to prepare a first timestamp-carrying message (TCM). The method further comprises adding at least the first DV value to the first timestamp value to obtain adjusted first timestamp value. The method additionally comprises performing the individual processing actions to form the first TCM, with the first TCM including the corrected first timestamp, and transmitting the first TCM to the target clock where the target clock is to receive the first TCM at a time have associated thereto a second timestamp value. The method also comprises receiving, from the target clock, a target clock message, sent by the target clock at a time corresponding to a third timestamp value. In response to the target clock message, a third timestamp value is obtained from the reference clock. The method further comprises calculating a second delay value (DV) in accordance with individual second processing delay values associated with the respective individual processing actions to be performed to prepare a second timestamp-carrying message (TCM), and adding at least the second DV value to the third timestamp value to obtain a corrected third timestamp value. The method further comprises performing the individual processing actions to form the second TCM, with the second TCM including the corrected third timestamp value and transmitting the second TCM to the target clock. The target clock is configured to: determine a time at which the second TCM is received, the time at which the second TCM is received corresponding to a fourth timestamp value. In accordance with the corrected first timestamp value, the second timestamp value, the corrected third timestamp value and the fourth timestamp value, the target clock is configured to calculate an offset of the target clock with respect to the reference clock and to adjust the target clock in accordance with the offset.

In accordance with a fourth aspect, the present disclosure provides a method performed at a non-terrestrial node (NTN) that has a reference clock. The NTN is part of a communication network that comprises a terrestrial node that includes a target clock. The method comprises obtaining an original timestamp based on the reference clock and generating a plurality of corrected timestamps in accordance with: a plurality of processing delay values (DAVs), each DAV of the plurality of DAVs being associated with a respective processing action of a plurality of processing actions to be performed to generate a timestamp-carrying packet; and a plurality of different time increments, each corrected timestamp of the plurality of corrected timestamps having a value that includes a sum of the plurality of DAVs and one different time increment of the plurality of different time increments. The method further comprises generating a plurality of timestamp-carrying packets with each timestamp-carrying packet of the plurality of timestamp-carrying packets comprising a respective different corrected timestamp of the plurality of corrected timestamps. The method additionally comprises determining a transmission time to transmit, to the terrestrial node, one of the timestamp-carrying packets of the plurality of timestamp-carrying packets and identifying, to obtain an identified timestamp-carrying packet, which of the plurality of timestamp-carrying packets has a corrected timestamp closest to the transmission time. The method also comprises transmitting, to the terrestrial node, the identified timestamp-carrying packet.

In some implementations of the fourth aspect, the method further comprises encapsulating the identified timestamp-carrying packet to obtain an encapsulated timestamp-carrying packet, and transmitting the encapsulated timestamp carrying packet to the terrestrial node.

In some implementations of the first aspect, second aspect, third aspect and fourth aspect, the NTN may be a satellite, a manned aerial vehicle or an unmanned aerial vehicle.

In a fifth aspect, the present disclosure provides an apparatus that comprises at least one processor coupled a non-transitory computer-readable medium having recorded thereon instructions that when executed by the at least one processor perform the method of any one of the first aspect of the present disclosure, the second aspect of the present disclosure, the third aspect of the present disclosure, the fourth aspect of the present disclosure and in their respective implementations described herein.

In some implementations of the firth aspects, the apparatus is a non-terrestrial node, or is a module/chipsets in the non-terrestrial node.

In some implementations of the firth aspects, the apparatus is a terrestrial node, or is a module/chipsets in the terrestrial node.

In some implementations of the firth aspects, the apparatus is a non-terrestrial node, such as the satellite, and the apparatus may further comprise or coupled to a reference clock.

In some implementations of the firth aspects, the apparatus may further comprise or coupled to a transmitter.

In some implementations of the above one or more aspects, the satellite may be replaced by a different type of non-terrestrial node, such as, for example, a manned aerial vehicle or an unmanned aerial vehicle. The manned aerial vehicle or the unmanned aerial vehicle may be part of a high altitude platform system or of another type of non-orbiting platform. The manned or unmanned aerial vehicles may be maintained aloft by atmospheric lift or by aerodynamic lift. In the manned aerial vehicle may be, for example, a plane, a helicopter or an aerostat. The unmanned aerial vehicle may be, for example, a drone or an aerostat. In a sixth aspect, the present disclosure provides a system comprising an apparatus performing the method of any one of the first aspect and the third aspect of the present disclosure, and an apparatus performing the method of any one of the second aspect of the present disclosure and the fourth aspect of the present disclosure.

In a seventh aspect, the present disclosure provides a non-transitory computer-readable medium storing instructions for performing the method of any one of the first aspect of the present disclosure, the second aspect of the present disclosure, the third aspect of the present disclosure, the fourth aspect of the present disclosure and in their respective implementations described herein.

In an eight aspect, the present disclosure provides a computer program comprising instructions for performing the method of any one of the first aspect of the present disclosure, the second aspect of the present disclosure, the third aspect of the present disclosure, the fourth aspect of the present disclosure and in their respective implementations described herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 shows a sequence flow diagram for the transmission of timestamps between clocks, according to the prior art.

FIG. 2 shows another sequence flow diagram for the transmitter of timestamps between clocks, according to the prior art.

FIG. 3 shows a block diagram of an embodiment of transmission portion of a timestamp correction system in accordance with the present disclosure.

FIG. 4 shows a flowchart of an embodiment of a method in accordance with the present disclosure.

FIG. 5 shows a flowchart of another embodiment of a method in accordance with the present disclosure.

FIG. 6 shows a flowchart of yet another embodiment of a method in accordance with the present disclosure.

FIG. 7A shows an embodiment of a satellite in orbit around the earth.

FIG. 7B shows an example of a variation in distance (range) between a source clock (satellite) and a target clock (terrestrial node), in accordance with the present disclosure.

FIG. 8 shows a block diagram of an embodiment of a timestamp correction system coupled to a receiver system in accordance with the present disclosure.

FIG. 9 shows an embodiment of a system according to the present disclosure.

FIG. 10 shows a flowchart of an embodiment of a method according to the present disclosure.

FIG. 11 shows and embodiment of an apparatus according to the present disclosure.

FIG. 12 shows an embodiment of an electronic device according to the present disclosure.

It will be noted that throughout the appended drawings, like features may be identified by like reference numerals.

### DETAILED DESCRIPTION OF ILLUSTRATIVE EMBODIMENTS

In the context of the present disclosure, the term “encapsulation” may be used to refer a communication-network process where layer-specific overhead (e.g., header and/or tailers) is concatenated with a payload (a service data unit) to form a protocol data unit (PDU), for transmitting the payload (data in the payload) between network elements (network nodes). Also, in the context of the present disclosure, the term “de-encapsulation” may be used to refer to a communication-network process that is the reverse of the encapsulation process (de-encapsulation removes from the PDU the concatenated header or footer.)

Conventional solutions to time distribution can be grouped into three main areas: (1) use of a dedicated system, (2) use of the traffic signal and (3) use of a dedicated message exchange mechanism. While all can distribute time, each may distribute time with varying levels of accuracy.

A well-known solution to the problem of time distribution is, in the prior art, the use of a global navigation satellite system (GNSS), such as GPS or Galileo, to provide a dedicated time-reference to a terrestrial receiver.

Another solution is to utilize the wireless traffic carrying signals as a mechanism to transport timing. This can limit the time error to a certain degree, but the dependency of the error on the distance from the source (e.g., gNB) can cause difficulties.

Another solution utilizes two-way exchange of timestamps between clocks. Each clock will timestamp the transmission and reception of timing-specific messages. A protocol is used to allow one clock to have access to transmitted and received timestamp information from both clocks allowing it to calculate the time-offset and thus adjust its clock to that of the other clock.

Existing satellite navigation systems can provide highly accurate time to end users. However, the use of GNSS requires a device to implement multiple radio systems: one for bi-directional user communication to and from a satellite data transmission network, and a second one for tracking and receiving time-information from a second dedicated GNSS constellation. Devices using the IIoT typically have low power, and in such cases, it is expected that the IIoT devices receiving timestamps would use a single satellite channel to achieve bi-directional communications, instead of using multiple radio systems. Additionally, because GNSS signals inherently have low power, the IIoT devices receiving them would be subject to security issues such as signal jamming and spoofing.

Where a traffic-carrying signal is itself used as a mechanism to transport timestamps; the methods rely on accurately ensuring that a specific radio frame is transmitted at a specific instant in time. The receiving device can then determine the time based on the time of arrival of the radio frame. The propagation delay, however, causes errors which therefore depend on the distance between the transmitter and receiver. When the transmitter or receiver is on a satellite, errors may become excessive. An orbit at an altitude of 300 km for example can result in a time error of 900 ms, which is outside MiFID requirements. Attempts to correct for delay due to the satellite require knowledge of the satellite position (ephemeris) and location at the terminal, to be provided by GNSS.

Regarding timestamp distribution using a dedicated timestamp message exchange, the level of accuracy can depend on the type of messages, the message rate, the network, as well as the specific mechanism involved. The network time protocol (NTP) is one of the earliest and best-known protocols for message-based time distribution. Although it can provide sufficient accuracy to set computer clocks, its accuracy is not sufficient to provide timing for telecommunications infrastructure, wireless infrastructure, and applications such as industrial automation. The precision time protocol (PTP) is more accurate than the NTP and allows improved synchronization and timestamping. However, the PTP may still be subject to network effects such as packet delay variation, which may impact the ability of a target clock to adjust its time to that of a source clock. The PTP also defines additional clock types such as boundary clocks and transparent clocks that help cope with network induced packet delay variation (PDV) and support hardware timestamping with additional follow-up messages.

Timestamps exchanged between a source clock and a target clock can allow the target clock to set its time to the source clock time. Two protocols for such timestamp exchanges include the NTP and the precision time protocol (PTP) of the IEEE 1588 standards. Both protocols are defined for terrestrial networks with stationary terminals.

To address higher accuracy requirements of devices on the wireless IIoT, time-distribution can be made to rely on the PTP, which is also used in IEEE's time-sensitive networking (TSN). Embodiments of the present disclosure may use a PTP with a method of wirelessly exchanging messages between a non-terrestrial node (e.g., a satellite) that is coupled to reference clock and a ground terminal (terrestrial node) that has a target clock supporting a device on the IIoT.

Implementations of the present disclosure include methods to allow the distribution of a timestamp over a two-way multi-user communication channel between a non-terrestrial node and a terrestrial node. An example of such communication channel is the New Radio (NR) channel defined by the 3GPP for 5G wireless service. Embodiments of the present disclosure may support standardization of time-sensitive networking (TSN) in a wireless network, using components such as those present in the system architecture specified in the 3GPP 23.501 technical specifications.

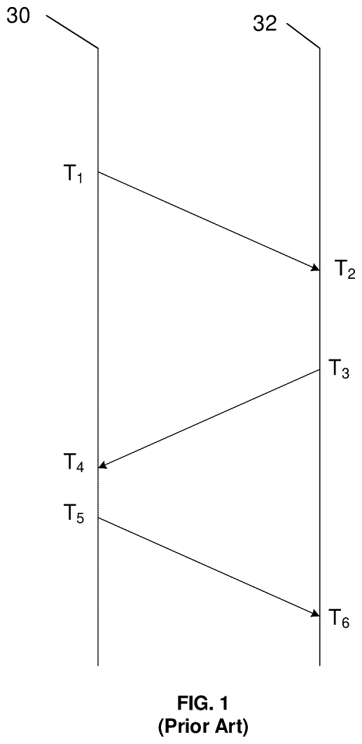

In the PTP sequence flow diagram of FIG. 1, the time at a source clock 30, according to prior art. At time T1 the source clock 30 generates the timestamp T1. The source clock 30 subsequently generates a message containing the timestamp T1 and sends the message (the timestamp T1) to the target clock 32.

At time T2 of the target clock 32, the target clock 32 receives the timestamp T1. The target clock 32 now has knowledge of two timestamps, namely T1 and T2. At time T3 of the target clock 32, the target clock 32 sends to the source clock 30 the timestamp T3, which is received at the source clock 30 at time T4 of the source clock 30. The source clock 30 subsequently sends, at time T5, to the target clock 32, the timestamp T4, which is received at the target clock at time T6.

As a result, the target clock 32 has knowledge of the timestamps T1, T2, T3 and T4, which allow the target clock 32 to calculate the delay of a message transmission between the source clock 30 and the target clock 32 (i.e., the delay D_ms between the master (clock 30) and the slave (target clock 32), the delay of a message transmission between the target clock 32 and the source clock 30 (i.e., the delay D_sm between the slave (target clock 32) and the master (source clock 30)), as well as any offset (Offset) between the target clock 32 and the source clock 30. The Offset and the delays may be calculated as follows:

$$T 2 - T 1 = Offset + D\_ms \qquad ( 1 )$$

$$T 4 - T 3 = - Offset + D\_sm \qquad ( 2 )$$

Generally, the propagation paths are approximately (substantially) symmetric and a simplifying assumption is made (D_ms=D_sm=D), which yields:

$$Offset = \frac{1}{2} ( T 2 - T 1 - T 4 + T 3 ) \qquad ( 3 )$$

$$D = T 2 - T 1 - Offset \qquad ( 4 )$$

Once this calculation is performed, the source clock only needs to generate and transmit (send) periodic messages that contain accurate timestamps to maintain accurate time at the target clock. When the propagation path between the source clock and the target clock is symmetric, equations (1)-(4) perform well; however, if the propagation path is not symmetric, such as when the source clock is on a fast-moving non-terrestrial node (e.g., a satellite), the error in the Offset and in the round-trip delay 2D will increase. Further, if there are variations in the delay between when a radio frame carrying a timestamp is ready for transmission and when the radio frame is transmitted, the Offset between the source clock 30 and the target clock 32 will vary.

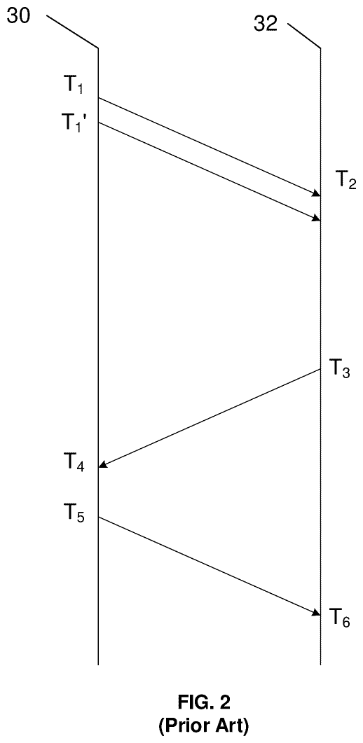

The accuracy of the timestamp T1 obtained by a target clock can be further improved, by having an additional, follow-up message sent from the source clock 30 to the target clock 32, with the follow-up message carrying a timestamp T1′, which is the time at which the timestamp T1 was sent (transmitted) from the source clock 30 to the target clock 32. After receiving the timestamps T1 and T1′, the target clock 32 can then use the time T1′ to correct for any system delays that occurred at the source clock 30 between when the timestamp T1 is generated and when the timestamp T1 is sent to the target clock 32. T1, T1′, T2, T3 and T4 are shown in the sequence flow diagram of FIG. 2. According to the PTP defined by IEEE 1588, T1′ may be determined by measuring the time at which the packet is sent from the source clock 30. The timestamp T1′ representing the time at which a message is sent can be contained within any suitable message type. When T1′ is available, equations (3) and (4) become:

$$Offset = \frac{1}{2} ( T 2 - T {1}^{′} - T 4 + T 3 ) \qquad ( 5 )$$

$$D = {T}_{2} - {T}_{1}^{′} - Offset \qquad ( 6 )$$

In some systems (e.g., Ethernet systems), T1′ may be obtained using timestamping hardware at the source clock. In systems supported by the IEEE 1588 standard, the message carrying T1′ may be referred to as a “follow-up” message. T1′, i.e., the timestamp reference point, is fixed and based on an Ethernet frame according to the IEEE 802 standards. Specifically, the timestamp is defined as the beginning of the first symbol after the start of frame delimiter. This may become problematic when the frame is mapped into a lower transport layer where there may be some additional variable delay due to the mapping process, which in turn may impact the accuracy of the timestamp. Subsequently, when the Ethernet frame is mapped to a radio specific frame to be carried over a non-terrestrial node channel (e.g., satellite channel) that may serve multiple users, additional delay is introduced, possibly together with a Doppler related delay (Doppler delay adjustment value). The Doppler related delay is present when the relative speed between the non-terrestrial node (e.g., a satellite) and the terrestrial node is non-nil. As will be understood by the skilled worker, the Doppler related delay may become important to consider when the relative speed (can also be referred to as the range rate) between the non-terrestrial node and the terrestrial node is non-nil and when the delay D (which may also be referred to as the time-of-flight delay) is substantial. As an example, the relative speed of a geocentric, circular orbit satellite towards a terrestrial node is zero when it is at its closed approach (e.g., directly overhead), despite the fact that the orbital speed may be in the range of km/second (e.g., a satellite at an altitude of 500 km is travelling with a speed of 7600 m/s.)

Rather than having a hardware device (hardware assist) determining T1′ and including T1′ in a follow-up message, embodiments of the present disclosure may forgo the need for a follow-up message to carry T1′, by adjusting the timestamp T1 before sending the message carrying the timestamp. By doing so, when the corrected T1 timestamp (T1c) is received at the target clock, it represents the time at which the message containing the timestamp was sent. In an embodiment, the delay between T1c and T1 may be obtained by calculating the value of T1c based on the time required to prepare the timestamp-carrying message, which may include the time required to encapsulate T1c in the timestamp-carrying message. A timestamp correction can therefore be applied to T1 to obtain T1c before T1c is encapsulated.

Furthermore, in some embodiments according to the present disclosure, other delays due to other delay mechanisms that may contribute to the total delay between the generation of the timestamp T1 at the source clock 30 and the reception of T1c at the target clock 32 may be taken into account when calculating T1c. In these embodiments, the timestamp (the corrected timestamp T1c) that is received at the target clock 32 is adjusted to anticipate the time required to prepare the timestamp-carrying message and for the other delay mechanisms.

An example of such another delay mechanism is a time-of-flight delay from a non-terrestrial node carrying the source clock (or coupled to a source clock) to the target clock. In some embodiments, the time-of-flight delay may be a function of the transmission path length for a transmitted message going from the non-terrestrial node (source clock) to the target clock. The transmission path length generally depends on the medium present between the non-terrestrial node and the target clock. When the target clock is on Earth, the medium includes vacuum and air. In some embodiments, the time-of-flight delay may also be a function of the transmission path length when going from the target clock to the non-terrestrial node.

Another example of a delay mechanism may include a relative-motion delay due to the relative motion of the non-terrestrial node (source clock) with respect to the target clock. In some embodiments of the present disclosure, the relative-motion delay may contribute in one transmission direction (from the non-terrestrial node to the target clock or from the target clock to the non-terrestrial node) or in both transmission directions (from the non-terrestrial node to the target clock and from the target clock to the non-terrestrial node).

In general, the accuracy achievable when synchronizing the target clock 32 with the source clock 30 can depend on multiple system factors, including system noise, delay mechanisms, and round-trip symmetry/asymmetry.

Some methods for synchronizing a target clock with that of a source clock may assume that the distance a message travels from the source clock to the target clock is the same to that from the target clock to the source clock (i.e., the paths are symmetrical). This assumption may be made when the message turnaround time—i.e., the time between receiving a message, then sending a reply—is sufficiently short. Otherwise, the path length may, in fact, differ. For example, as the speed at which a non-terrestrial node travels may be in the range of kilometers/second, the distance between the non-terrestrial node and ground-based receiver may change considerably in a short time span. For reasonable implementations, the path distance variation should be small.

Any variation in the system's clock accuracy would add to the time error at the target clock. The required accuracy of a target clock in a system generally depends on the specific application, which may have unique timing requirements. In general, the drift in an oscillator used in a source clock will cause a timing error. In some cases, it may be possible to utilize a lower cost oscillator but accommodate its poor drift performance with more frequent synchronization message exchanges. But, at some point, this may not be possible. For cases where high accuracy is required, better oscillators are usually required. For example, a system designer can select, for a source clock, an oscillator to provide an acceptable degree of time accuracy, considering drift rates such as a drift rate caused by temperature variations. To have a highly accurate time-base, a source clock might use an oscillator-based on atomic transitions of the cesium or rubidium atoms. For less critical applications, a lower cost source clock using other materials as oscillators, such as quartz-based crystals (known as crystal oscillators (XOs), can be used.

Oscillator-based clocks may be temperature-controlled (e.g., an ovenized compensated crystal oscillator or “OCXO”) or temperature-compensated (e.g., temperature-compensated crystal oscillator, “TCXO”). The type of oscillator selected can depend on many factors including cost and power requirements. For some low power devices, such as some Internet of things (IoT) or industrial internet-of-things (IIoT) devices, power constraints might prevent the use of ovenized oscillators, despite the need for high accuracy.

In some embodiments of the present disclosure, any suitable type of timestamp-carrying message may be transmitted from a source clock to a target clock. For example, timestamp-carrying messages compliant with IEEE 1588 standards may be used. Other types of timestamp-carrying messages may include NTP messages, which may be less precise. According to embodiments of the present disclosure, the way a target clock processes a timestamp can be according to a specific manner that is compliant with the IEEE 1588 standards, but a source clock (i.e., the source of timestamps) can pre-adjust a reference timestamp T1 such that the accuracy at the target clock is increased or maximized.

According to embodiments of the present disclosure, processes for sending a timestamp for a source clock to a target clock may include encoding (mapping, encapsulating) the timestamp to an Ethernet frame for subsequent transmission over a transmission channel. For a shared wireless channel, the encoding may involve multiple protocols, some of which being specific to the transmission channel. For example, a wireless network using an orthogonal frequency-division multiplexing (OFDM) transmission channel (e.g., LTE-A, 5G, etc.) may encode the timestamp data using the service data adaptation protocol (SDAP). The timestamp data encoded using the SDAP may be further mapped using another protocol such as the packet data convergence protocol (PDCP). In the case of a shared medium, such as in a wireless system, the present disclosure provides, in some embodiments, an encoding controller is used to control (coordinate) each encoding step of the timestamp (timestamp data) into a frame and may be further used to assign and allocate the resources available at the source clock (CPU, bandwidth, memory, etc.) needed for the encoding steps. According to embodiments of the present disclosure, using the resources available at the source clock, the timestamp data can be modulated onto a carrier signal via a radio link control (RLC), a medium access control (MAC) layer and a physical (PHY) layer. Once the timestamp data has been modulated as symbols to the carrier signal, it can be carried across the transmission channel, to the target clock.

At each encoding step, a varying degree of buffering may be required, thus contributing to an additional delay in transmitting the timestamp data, and ultimately decreasing the accuracy of the timestamp. For example, in a satellite network, where the length of the transmission channel varies according to the distance between a satellite in motion and a ground terminal, the varying channel length may also be a significant source of delay.

At a target clock, a reverse process can then be performed to extract T1 data from the symbols to de-map the message carrying T1 from protocol layers, and to allow the target clock to receive and read the T1 timestamp.

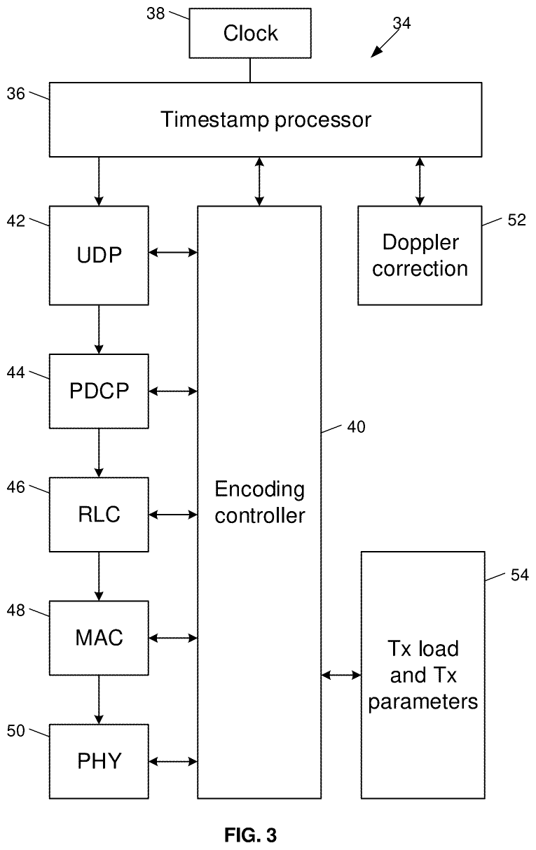

FIG. 3 shows a block diagram of an embodiment of timestamp correction system (TCS) 34 in accordance with the present disclosure. The TCS 34 comprises a timestamp processor 36 configured to receive a timestamp from a clock 38 (e.g., a source clock comprised in a satellite) and to correct the timestamp for the delay between the generation of the timestamp and the moment when the timestamp is transmitted to a target clock. The timestamp processor 36 may be coupled to an encoding controller 40, which may be coupled to each of a plurality of modules (processing modules) configured to process the timestamp data to generate a timestamp-carrying message. The plurality of modules may include at least one of a user datagram protocol (UDP) module 42, a PDCP module 44, a RLC module 46, a MAC module 48 and a PHY module 50. In other embodiments of the present disclosure, the TCS may exclude a clock but instead may be configured to receive a time signal from an external clock. In embodiments where the TCS is located in a non-terrestrial node, the non-terrestrial node may be configured to receive a time signal from, for example, a satellite or from another non-terrestrial node or from an earthbound clock. In some embodiments, the TCS may comprise a transparent clock configured to receive an external time signal from a reference clock. When an embodiment of the TCS of the present disclosure is in a non-terrestrial node that does not include a clock per se, but instead receives a time signal from an external source, the non-terrestrial node may be said to operate as a (reference) clock.

In the embodiment of FIG. 3, for some of the plurality of modules, the time required for processing timestamp data received from the timestamp processor 36 through any intervening module may vary in accordance with a varying degree of buffering that may be required at each module, which ultimately increases the time error. For high accuracy applications, it is important to consider the buffering at each processing module and buffering variations at each processing module. Each of these processing modules may have stored thereat a respective preset delay value that can be provided to the encoding controller 40 upon request. The preset delay value may account for buffering of the data and processing of the data. In some embodiments, the respective preset delay values may be stored at the encoding controller 40. On the other hand, for other modules, the time for processing the timestamp data received from the timestamp processor 36 through any intervening module may vary depending on certain processing factors. For example, the processing time required by a module may depend on protocol-specific processing, processing resource availability, etc. In some embodiments, each protocol layer will generally have a buffering component associated thereto. Certain protocols will have procedures that may impact delay, for example, the PDCP module 44 may buffer management requirements that may vary due to the implementation of the strategy chosen by the designer. The RLC module 46 may manage the radio link and initiate error recovery. This is transparent to the higher layers and will result in delays that would be dependent on the channel bit error rate. OFDM-MA (multiple access) is responsible for allocating the individual resource blocks that will carry the user data, these are in different locations in the OFDM frame, and will also result in timing offset relative to the original timing reference point of the timestamp frame. Finally, since the ODFM symbol rate is much slower than the original user data rate (the data is spread over multiple carriers), the user data may have to be buffered until the OFDM symbol can be transmitted. This is similar, in effect, to waiting time jitter, in classic plesiochronous digital hierarchy (PDH) transmission schemes involving asynchronous mapping.

In the TCS 34 of FIG. 3, it may be reasonable to expect the UDP module 42 to be a source of a same delay value for all incoming data to be processed, or to have an upper bound delay value. In some embodiments, the expected (same) delay value or the upper bound delay value may be based on historical timestamp data processing by the UDP module 42. As such, the delay value for the UDP module 42 may be set to the expected delay or to the upper bound value.

Similarly, the PCDP module 40 may be expected to be the source of a respective same delay value or to have a respective upper bound delay value. As such, the delay value for the PCDP module 44 may be set to the respective expected delay or to the respective upper bound delay value.

The RLC module 46, on the other hand, may be expected to be the source of a variable delay when having to schedule processing data from multiple users using the same specific resources (resource blocks). Because of this possibility, the RLC module 46 may be configured to estimate a processing delay based on recent and/or current requests requiring usage of the same specific resources. For example, the RLC module 46 may be configured to estimate the processing delay based on an anticipated system state at the next timestamp transmission.

Like the RLC module 46, the MAC module 48 may also be expected to be the source of a variable delay when having to process data from multiple users using the same specific resources (resource blocks). Because of this, the MAC module 48 may be configured to estimate a processing delay based on recent and/or current requests requiring scheduled usage of the same specific resources. For example, the MAC module 48 may be configured to estimate the processing delay based on an anticipated system state at the next timestamp transmission.

The PHY module 50 may be configured to operate using different modulation methods with their respective specific parameters such as, for example, symbol duration, number of bits per symbols, etc., or to operate under an adaptive modulation approach where the processing of data may fall back to a slower bit rate due to varying communication channel conditions. Because of this, the PHY module 50 may be configured to estimate its processing delay based on the modulation method that will be used along with the respective specific parameters of the method. The PHY module 50 may also be configured to estimate its processing time taking into account any adaptive modulation that may be required.

In order to account for multiple users requiring use of the TCS 34 or individual requests requiring the use of some of the resources used by any of the UDP module 42, the PCDP module 44, the RLC module 46, the MAC module 48, the PHY module 50 and the encoding controller 40, the TCS 34 may comprise a transmission load and transmission parameters (TLTP) module 54, which may be configured to track the type and the number of requests that may need to access the modules of the TCS 34 or the resources used by the modules of the TCS 34. The TLTP module 54 may also be configured to track the requirements (parameters) of the signals to be transmitted (e.g., the bit rate, the symbol duration, the number of bits per symbol, etc.) The encoding controller 40 may be coupled to the TLTP module 54 and may communicate to the other modules coupled to the encoding controller 40, the data obtained from the from the TLPT 54. The TLTP module 54 is shown as a single block for the purposes of clarity of explanation; however, as will be understood by the skilled worker, functions of the TLTP module 54 may be distributed or implemented in the UDP module 42, the PCDP module 44, the RLC module 46, the MAC module 48, the PHY module 50 and/or the encoding controller 40.

In some embodiments, the TCS 34 may also include a Doppler correction module (DCM) 52, which may be referred to as a path length variation module. The DCM 52 may be configured to determine a rate of variation in the distance between the source clock from the target clock. The DCM 52 may be configured to calculate the rate at which the distance between the source clock and the target clock varies based on the value of the frequency of a signal transmitted to the target clock and the value of the frequency observed in the signal received at the target clock. As will be understood by the skilled worker, the rate at which the distance between the source clock and the target clock varies may be used to calculate, as a function of time, the variation in path length between a non-terrestrial node carrying a source clock and an earthbound station/antenna containing a target clock. The variation in path length may cause a non-negligible variation in the transmission delay.

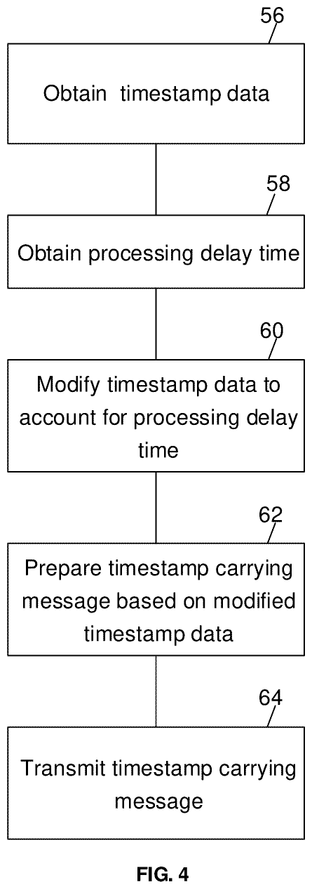

FIG. 4 shows a flowchart of an embodiment of a method of adjusting a timestamp according to an embodiment of the present disclosure. At action 56, a processor obtains a timestamp (timestamp data) from a clock (e.g., a non-terrestrial node source clock). The processor may obtain the timestamp directly form the clock or through one or more intervening modules. At action 58, the processor may obtain, e.g., from an encoding controller or from any other suitable module, a processing delay value calculated by the encoding controller. The processing delay value may be the sum of the delays encountered at processing steps required to prepare a timestamp-carrying message containing the timestamp (timestamp data). At action 60, a timestamp-carrying message may be prepared in accordance with timestamp data and in accordance with the processing delay time. Effectively, the modified timestamp data may include the original timestamp data to which the processing delay time is added.

At action 62, the timestamp-carrying message is prepared and, at action 64, the timestamp-carrying message is transmitted to a target clock. The target clock and the source clock may subsequently exchange additional time-carrying messages and apply equations (5)-(6) to calculate the offset between clocks and the distance therebetween.

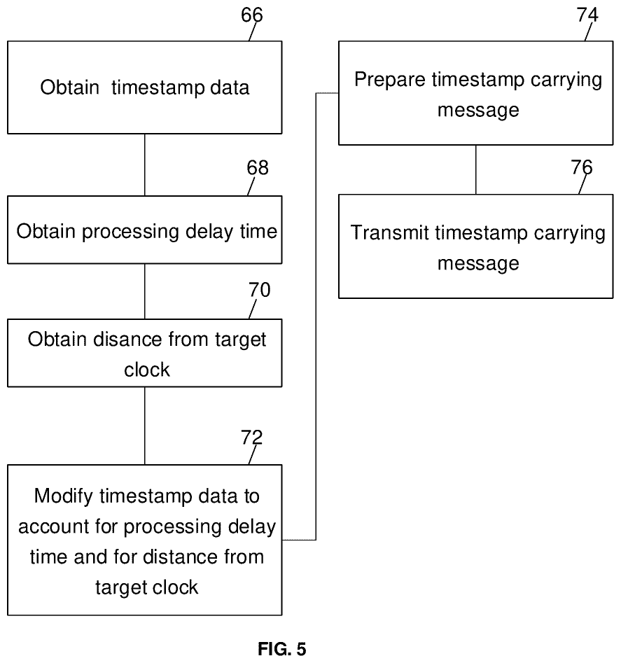

FIG. 5 shows a flowchart of another embodiment of the method according to the present disclosure. Actions 66 and 68 of FIG. 5 may be the same as actions 56 and 58 of FIG. 4. At action 70 of FIG. 5, the processor may obtain a distance separating the source clock from the target clock. The distance may be based on a distance table that may be accessed by the processor or may be based on the position of the target clock with respect to the non-terrestrial node; the position of the non-terrestrial node and of the target clock may be based on respective GPS signals received at the non-terrestrial node and at the target clock. Subsequently, at action 72, the timestamp data may be modified to account for the processing delay time and for the time-of-flight between the source clock and the target clock. The time-of-flight may be calculated based on the distance separating the source clock from the target clock. In this scenario, in conditions where the distance between the source clock and the target clock is constant or sufficiently constant to satisfy timing specifications, no additional exchange of timestamp between the target clock and the source clock may be necessary. At FIG. 5, actions 74 and 76 follow and may be the same as action 62 and 64 from the embodiment of FIG. 4.

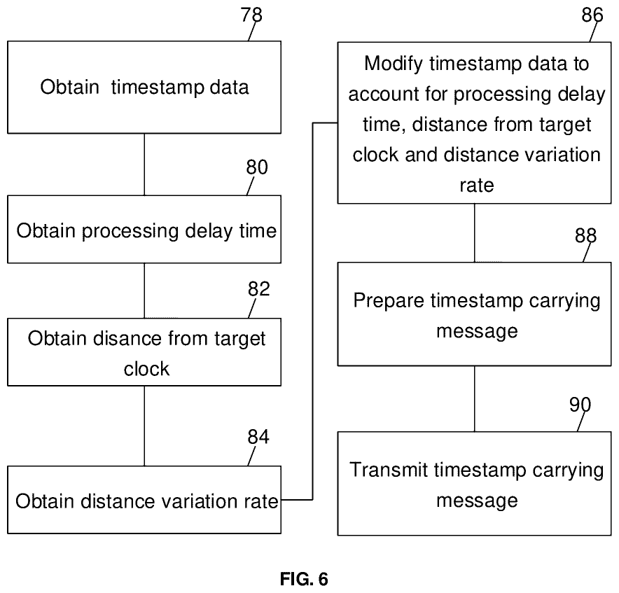

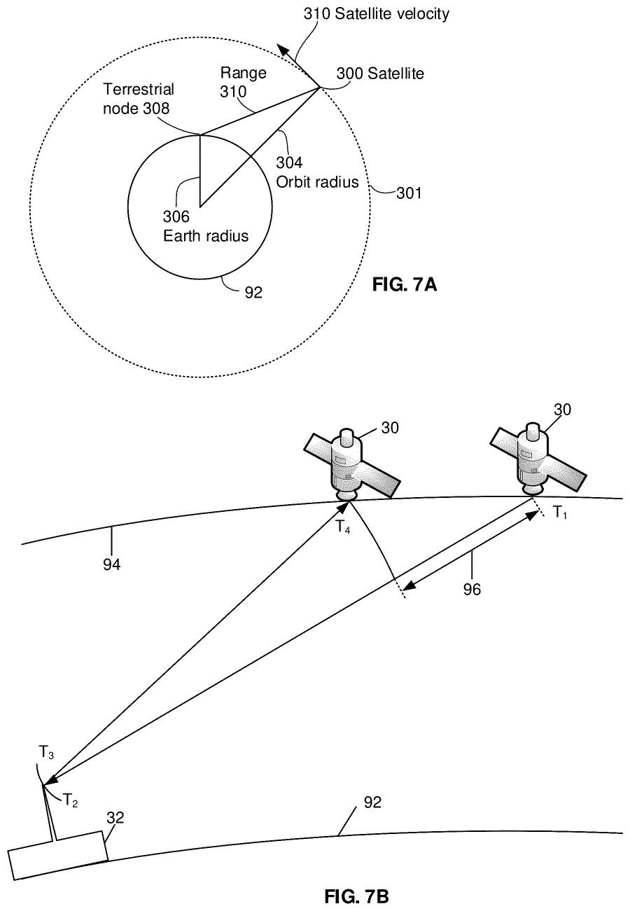

FIG. 6 shows a flowchart of yet another embodiment of the method according to the present disclosure. Actions 78, 80 and 82 of FIG. 6 may be the same as actions 66, 68 and 70 of FIG. 5. At action 84 of FIG. 6, the processor may obtain a value of the rate of variation of the distance between the non-terrestrial node (coupled to the source clock) and the target clock. The value may include a Doppler compensation value. The variation in distance may be small but can vary based on the time between message exchanges. FIG. 7A shows a satellite 300 (which is a non-limiting example of a non-terrestrial node) in orbit 301 around the earth 92, the satellite's orbit radius 304, the earth's radius 306, a terrestrial node 308, the range 310 of the satellite with respect to the terrestrial node 308, and the satellite velocity vector 310. FIG. 7B shows an example of a variation in distance (range) between a source clock 30 (satellite) in orbit and a target clock 32 (station/antenna) on Earth 92. In this example, T2−T1 is the delay from the source clock 30 to the target clock 32, and T4−T3 is the delay from the target clock 32 to the source clock 32. In the example of FIG. 7, the source clock 30 (satellite) has moved between the moment the source clock 30 sent a first message at T1 and the moment the source clock 30 received a second message from the target clock 32 at T4. The change in distance is shown at reference number 96. The path travelled by the source clock 30 is shown at reference number 94. When the source clock 30 (satellite) is directly overhead, this change in distance would be minimized. If the source clock 30 (satellite) knows its location and the location of the target clock 32 (station/antenna), then the change in distance can be quantified and factored into subsequent timestamps sent from the source clock 30 to the target clock 32.

Returning to FIG. 6, action 86 may modify the timestamp to account for the processing delay time, the distance from the target clock and the distance variation rate between the non-terrestrial node and the terrestrial node, which includes the target clock 110. Actions 88 and 90 may be the same as actions 74 and 76 shown in the embodiment of FIG. 5.

The system of FIG. 3 and the methods shown in the flowcharts of FIGS. 4-6 may be used when correcting timestamp data being sent from a source clock to a target clock.

After preparation (encapsulation), the timestamp-carrying message (TCM) (frame) can be transmitted to a receiver system in the target clock over a channel and a reverse, de-capsulation process can take place at the receiver system. That is, the timestamp received the receiver system in the target clock may be subjected to processing steps and be corrected in accordance with the processing delay at each of the processing steps.

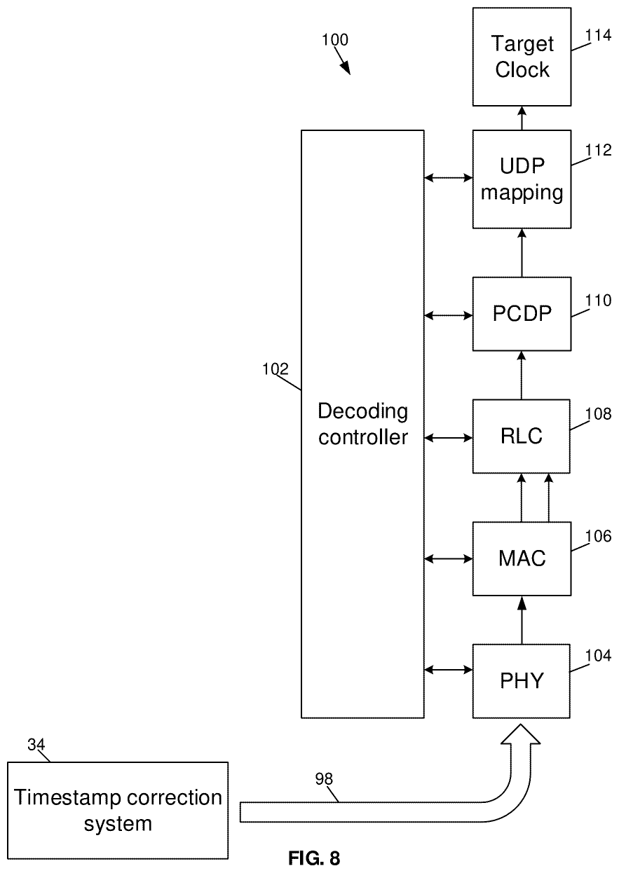

FIG. 8 shows an arrangement of a TCS 34 transmitting, through a channel 98, a TCM, to a receiver system 100. The receiver system 100 may comprises a decoding controller 102, a PHY module 104, a MAC module 106, an RLC module 108, a PCDP module 110, and a UDP module 112. The receiver system 100 is configured to receive, from a non-terrestrial node (e.g., a satellite), the TCM generated at the non-terrestrial node and to de-encapsulate the TCM in order for the TN to obtain the adjusted timestamp contained in the TCM. De-encapsulating the TCM may comprise performing a plurality of terrestrial node processing actions (TNPAs) having associated thereto a plurality of terrestrial node processing delay values (TNPDVs). Each TNPA of the plurality of TNPAs is associated with a respective TNPDV of the plurality of TNPDVs. The plurality of TNPDVs may include computing a sum of the plurality of TNPDVs to obtain a total TNPDV; and subtracting the total TNPDV from the corrected timestamp to obtain an adjusted timestamp.

The system of FIG. 3 and the methods shown in FIGS. 4-6 may also be used when correcting timestamp data being sent from a target clock to a source clock or when correcting timestamp data being received from a target clock. As will be understood by the skilled worker, in these cases, the functions of the source clock and the target clock switch.

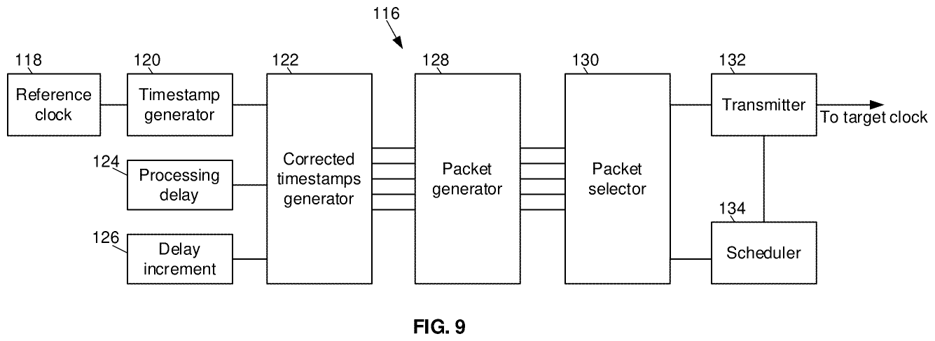

FIG. 9 shows an embodiment of a system 116 according to the present disclosure. The system 116, which may be located on a non-terrestrial node, includes a reference clock 118, a timestamp generator 120, a corrected timestamps generator 122, a processing delay device 124, and a delay increment device 126.

At a predetermined moment, when the system 116 is to provide a reference time to a target clock (e.g., located at a terrestrial node), or upon any criteria for generating a timestamp-carrying packet (or message) being satisfied, the timestamp generator 120 generates a timestamp in accordance with the time indicated at the reference clock 118 and provides the timestamp to the corrected timestamps generator 122. The processing delay device 124 obtains or monitors the processing delay values for each processing action required to generate the timestamp-carrying packet (or message). For example, when generating the timestamp-carrying packet requires encapsulation actions to encapsulate the timestamp (the timestamp data) the processing delay device 124 may obtain the processing delay value for each of the encapsulating actions. The processing delay device 124 may obtain the processing delay values from the modules that perform the encapsulation actions or from a memory (not shown) that stores processing delay values.

The DAVs may have associated thereto a statistical distributions and the processing delay values may have values corresponding to a statistical parameter of the respective statistical distribution. In a non-limiting example, the statistical parameter may be an expected value, a median value, an average value, or a maximum value. In some embodiments, the statistical distribution may be based on historical processing delay values or on modeling (statistical modeling) of the system 116. In some embodiments, the DAVs may be predicted values based on the historical processing delay values or on the modeling of the system.

The processing delay device 124 or the corrected timestamps generator 122 may also sum (add) all the processing delay values to obtain a total processing delay value. The processing actions may also include actions that are not related to encapsulating the timestamp data. As an example of a non-encapsulation action, there is the action adding all the processing delay values. The delay processing device 124 may provide the total processing delay value to the corrected timestamps generator 122.

The delay increment device 126 is a device that holds or generates a series of different time increments and provides the different time increments to the corrected timestamps generator 122. Alternatively, the corrected timestamps generator 122 may hold or generate the different time increments.

The correct timestamps generator 122 is configured to generate a series of different corrected timestamps in accordance with the timestamp generated by the timestamp generator 120, the total delay value, and the different time increments. Each of the series of corrected timestamps will have a value that is the timestamp generated by the timestamp generator 120 plus the total delay value plus one of the different time increments. The series of different corrected timestamps is provided to a packet generator 128 that generates, for each different corrected timestamp, a respective timestamp-carrying packet that carries the corrected timestamp. The timestamp-carrying packets are provided to a packet selector 130.

Each of the timestamp carrying packet may be encapsulated in a physical layer format and be ready for transmission, by a transmitter 132, to a target clock (terrestrial node that includes the target clock). Depending on the resources at the non-terrestrial node, or at any location where the reference clock is located, and also depending on the volume of requests being serviced by those resources, it may be necessary to schedule when a timestamp-carrying packet will be transmitted to the target clock. A scheduler 134 coupled to the transmitter 132 and to the packet selector 130 schedules a time for the transmitter 132 to transmit a timestamp carrying packet and provides the scheduled time to the packet selector 130. In turn, the packet selector 130 selects the timestamp-carrying packet that has a corrected timestamp closest to the scheduled transmission time and the transmitter 132 transmits the selected timestamp-carrying packet to the target clock. In some embodiments, the corrected timestamps generator 122 may have coupled thereto additional modules (not shown) that provide additional delay values that are to be included (accounted for) in the total delay value. As an example, one such additional module may be configured to obtain a time-of-flight delay for a message transmitted by the transmitter 132 to reach the target clock.

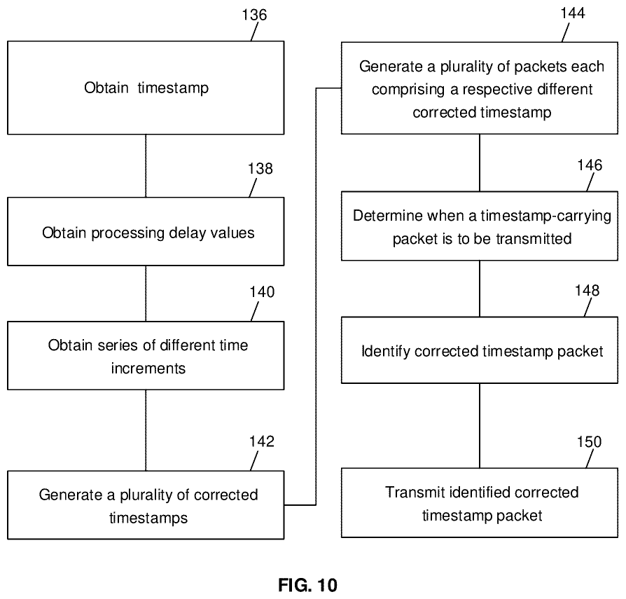

FIG. 10 shows a flowchart of an embodiment of a method according to the present disclosure. At action 136, at a non-terrestrial node (e.g., a satellite) that includes a reference clock, an original timestamp based on the reference clock is obtained. At action 138, processing delay values associated to the processing actions needed to generate a timestamp-carrying message are obtained. At action 140, a series of different delay increments are obtained. At action 142, a plurality of corrected timestamps are generated. Each corrected timestamp has a value that includes a sum of the original timestamp, the processing delay values and one different time increment of the series of different time increments. At action 144, a plurality of timestamp-carrying packets each comprising a respective different corrected timestamp are generated. At action 146, the time at which a timestamp-carrying packet is to be transmitted is determined. At action 148, identification is made of which of the plurality of timestamp-carrying packets has a corrected timestamp closest to the time at which the timestamp-carrying packet is to be transmitted. At action 150, the identified timestamp-carrying packet is transmitted.

In summary, the present disclosure provides a method for obtaining a timestamp issued by a reference clock (e.g., a non-terrestrial node clock); changing the timestamp to a corrected timestamp in accordance with an encapsulation delay, the encapsulation delay obtained from an encapsulation schedule; encapsulating the corrected timestamp in a frame in accordance with the encapsulation schedule; and transmitting the frame to a node.

Changing the timestamp to a corrected timestamp in accordance with a transmission delay can include considering an interval of time required for the frame to propagate from the non-terrestrial node to the node, where the time interval depends on a propagation distance separating the non-terrestrial node and the node, and a propagation medium between the non-terrestrial node and the node, and one or more wavelengths of the frame.

Other delays that can be considered to include a buffering delay being an interval of time required for obtaining the timestamp issued by the non-terrestrial node clock; a resource allocation delay being an interval of time required for determining resources required for transmitting the frame to the node; a resource allocation delay being an interval of time required for determining a field of the frame in which to encapsulate the corrected timestamp; a delay from mapping the corrected timestamp to the frame using a service data adaptation protocol (SDAP); a delay from mapping the corrected timestamp to the frame using a packet data convergence protocol (PDCP); a delay from modulating the corrected timestamp onto a MAC layer of the frame; a delay from modulating the corrected timestamp onto a PHY layer of the frame; a delay from a Doppler effect between the non-terrestrial node and the node, the Doppler effect being a function of a velocity of the non-terrestrial node, and a velocity of the node; as well as other delays that may be known.

At a target node receiving a timestamp, a method for a processor can include obtaining a received frame carrying the received timestamp; decapsulating the received timestamp from the received frame in accordance with a de-encapsulation schedule; and changing the received timestamp to a corrected timestamp in accordance with a de-encapsulation delay. In some embodiments, the de-encapsulation delay may be obtained from the encapsulation schedule.

A de-encapsulation delay can include any of a buffering delay caused by buffering the received timestamp, a timing advance related to a long-term evolution (LTE) radio interface, a timing advance related to a 5G new radio (NR) interface, a delay from a de-mapping process, and a delay from de-modulating the received timestamp from a MAC layer of the received frame.

Another delay that can be considered is a transmission delay being an interval of time required for the received frame to propagate from the non-terrestrial node to the node, such interval of time being a function of a propagation distance separating the non-terrestrial node and the node, a propagation medium between the non-terrestrial node and the node, and one or more wavelengths of the received frame.

Another delay that can be considered is a delay from a Doppler effect between the non-terrestrial node and the node, the Doppler effect being a function of a velocity of the non-terrestrial node, and a velocity of the node.

In an embodiment, an end-to-end path between a source clock and a target clock can be seen to include three parts: a transmit portion, a channel portion and a receive portion. Each of these parts adds a delay and therefore impacts the time error. However, the accuracy may be improved by anticipating the delays incurred at each of those three points in the system.

In the case of a transmission channel where a propagation distance varies in accordance with non-terrestrial node movement, a corresponding variable delay may be calculated. Such a calculation can use as input any of a non-terrestrial node's (source clock) position, a signal's propagation direction, a ground station's position, a Doppler effect adjustment and other relevant inputs. If using a radio interface such as LTE, or 5G NR, a calculation can also involve timing advance. Once the packet is received, the target clock can use the included timestamp directly, or apply one or more further corrections that account for other delays.

In an embodiment, the time delay it takes for a frame to propagate from a source clock to a specific target clock at a known location can be determined and adjusted in anticipation. By determining the expected time of arrival of a frame carrying a timestamp T1, a system can use a unidirectional time setting message. Such a process does not require a bidirectional exchange of messages and is essentially a fire-and-forget type of process.

In an embodiment, a delay in the time it takes for an Ethernet frame carrying a timestamp to propagate from a source clock to a target clock, or from a target clock to a source clock can be anticipated and adjusted. By applying such adjustment to a generated timestamp, before sending an Ethernet frame carrying the timestamp, a system is then operative to send a timestamp in a single transmission (i.e., one-shot distribution capability).

A time interval can be calculated before a frame carrying a timestamp is sent from a target clock to the source clock. Later, when the target clock is indeed about to send a timestamp to the source clock, the timestamp can be adjusted before being sent. In this situation, the target clock has an estimate of the time delay caused by the propagation distance, hence a further correction of channel delay is not required.

In an embodiment, time intervals during which an Ethernet frame carrying a timestamp is emitted from a source clock, is received at a target clock, is emitted from a target clock, or is received at a source clock, can be anticipated with an adjustment. By applying such adjustment to a generated timestamp, before the generated timestamp is sent, and/or after the generated timestamp is received, a target clock can obtain a timestamp having a reduced or minimized error.

Embodiments can be used in any of a terrestrial network, a wireless network, an ethernet network, and a WIFI network.

Embodiments provide a mechanism that is independent of distance from a source clock such as a gNB deployed in a non-terrestrial node, and therefore improve timing aspects in a system where timestamps sent from a gNB is not assumed to be perfect timing.

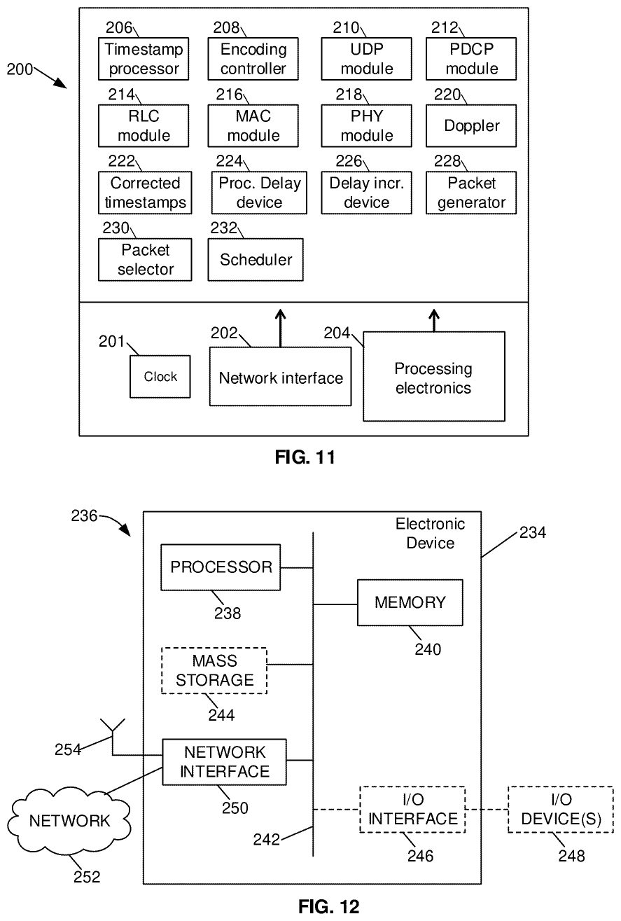

FIG. 11 shows an embodiment of an apparatus 200 for generating and transmitting a timestamp-carrying message according to embodiments of the present disclosure. The apparatus may be located at the non-terrestrial node 30 shown in the embodiment of FIG. 7. Returning to FIG. 11, the apparatus 200 may comprise a reference clock 201, a network interface 202 and processing electronics 204. The processing electronics 204 may include a computer processor executing program instructions stored in memory, or other electronics components such as digital circuitry, including for example field programmable gate arrays (FPGAs) and application-specific integrated circuits (ASICs). The network interface 202 may include a radio communication interface, such as a transmitter, a receiver or a transceiver. The apparatus 200 may include several functional components, each of which is partially or fully implemented using the underlying reference clock 201, the network interface 202 and the processing electronics 204. In some embodiments, the functional components may include some or all of: a timestamp processor or a timestamp generator 206, an encoding controller 208, a UDP module 210, a PDCP module 212, a RLC module 214, a MAC module 216, a PHY module 218, a Doppler correction module 220, a corrected timestamps generator 222, a processing delay device 224, a delay increment device 226, a packet generator 228, a packet selector 230, and a scheduler 232.

FIG. 12 shows a block diagram of an embodiment of an electronic device 234 illustrated within a computing and communications environment 236 that may be used for implementing the devices and methods disclosed herein, such as a system for generating a timestamp, a system for processing a timestamp and a system for scheduling the generating or the processing of a timestamp. The electronic device 234 includes a processor 238, such as a central processing unit (CPU), and may further include specialized processors such as a field programmable gate array (FPGA) or other such processor, a memory 240, and a bus 242 to connect the components of electronic device 234, which may optionally also include components such as a mass storage device 244, and an I/O interface 246 (shown in dashed lines) configured to connect to one or more I/O devices 248.

The memory 240 may comprise any type of non-transitory system memory, readable by the processor 238, such as static random-access memory (SRAM), dynamic random-access memory (DRAM), synchronous DRAM (SDRAM), read-only memory (ROM), or a combination thereof. In an embodiment, the memory 240 may include more than one type of memory, such as ROM for use at boot-up, and DRAM for program and data storage for use while executing programs. The bus 242 may be one or more of any type of several bus architectures including a memory bus or memory controller, a peripheral bus, or a video bus.

The electronic device 234 may also include a network interface 250, which may include at least one of a wired network interface and a wireless network interface. The network interface 250 may include a wired network interface to connect to a network 252, and also may include a radio access network interface 254 for connecting to other devices over a radio link. The network interface 250 allows the electronic device 234 to communicate with remote entities such as those connected to network 252.

The mass storage 244 may comprise any type of non-transitory storage device configured to store data, programs, and other information and to make the data, programs, and other information accessible via the bus 242. The mass storage 244 may comprise, for example, one or more of a solid-state drive, hard disk drive, a magnetic disk drive, or an optical disk drive. In some embodiments, mass storage 244 may be remote to the electronic device 234 and accessible through use of a network interface such as interface 250. In the illustrated embodiment, mass storage 244 is distinct from memory 240 and may generally perform storage tasks compatible with higher latency but may generally provide lesser or no volatility. In some embodiments, mass storage 244 may be integrated with the memory 240.

In an embodiment, an apparatus or a system for processing a timestamp can comprise at least one processor 238; a tangible, non-transitory machine readable (computer-readable) memory 240 having recorded thereon instructions to be carried-out by the at least one processor 238 to perform any method disclosed in the present disclosure.

In some embodiments, electronic device 234 may be a standalone device, while in other embodiments electronic device 234 may be resident within a data center. A data center, as will be understood in the art, is a collection of computing resources (typically in the form of servers) that can be used as a collective computing and storage resource. Within a data center, a plurality of servers can be connected together to provide a computing resource pool upon which virtualized entities can be instantiated. Data centers can be interconnected with each other to form networks consisting of pools of computing and storage resources connected to each other by connectivity resources. The connectivity resources may take the form of physical connections such as ethernet or optical communications links, and in some instances may include wireless communication channels as well. If two different data centers are connected by a plurality of different communication channels, the links can be combined together using any of a number of techniques including the formation of link aggregation groups (LAGs). It should be understood that any or all of the computing, storage, and connectivity resources (along with other resources within the network) can be divided between different sub-networks, in some cases in the form of a resource slice. If the resources across a number of connected data centers or other collection of nodes are sliced, different network slices can be created.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly (e.g., physically or electronically) connected to one another or connected to one another through one or more intermediate elements or devices via, for example, a mechanical element or an electronic element, depending on the particular context. The term “and/or” herein when used in association with a list of items means any one or more of the items comprised in that list.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and every modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure of some or all of its components in accordance with the system of the technology.

Actions associated with the method described herein can be implemented as coded instructions in a computer program product. The computer program product may be a computer-readable medium upon which software code is recorded to execute the method when the computer program product is loaded into memory and executed on the microprocessor of the non-terrestrial node or terrestrial node.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method at a non-terrestrial node (NTN), the method comprising:
obtaining an original timestamp based on a reference clock;
generating a timestamp-carrying message (TCM) that includes an adjusted timestamp by performing a plurality of processing actions having associated thereto a plurality of delay adjustment values (DAVs), each processing action of the plurality of processing actions being associated with a respective DAV of the plurality of DAVs, the plurality of processing actions including:
computing a sum of the plurality of DAVs to obtain a total DAV;
adding the total DAV to the original timestamp to obtain the adjusted timestamp; and
encapsulating the adjusted timestamp to form the TCM;
and
transmitting the TCM to a terrestrial node (TN) for an adjustment of a time on a TN clock by the TN clock in accordance with the adjusted timestamp, wherein the NTN is comprised in a communication network, and the communication network further comprises the TN, and the TN comprises the TN clock.

2. The method of claim 1, wherein the NTN comprises the reference clock.

3. The method of claim 1, wherein:
the TCM is a first message,
the adjusted timestamp is a first timestamp, and
the first message is received at the TN at a time on the TN clock that has a corresponding second timestamp, the method further comprising, at the NTN:
receiving, from the TN, a second message transmitted to the NTN at a time on the TN clock that has a corresponding third timestamp, the second message being received at the NTN at a time on the reference clock that has a corresponding fourth timestamp;
in response to the second message, transmitting, to the TN, a third message containing the fourth timestamp, the TN configured to calculate, based on the first timestamp, the second timestamp, the third timestamp and the fourth timestamp:
an offset of the TN clock with respect to a time at the NTN; and
a propagation delay for a message transmitted from the NTN to reach the TN, the TN being further configured to correct the time on the TN clock according to the offset and the propagation delay.

4. The method of claim 1, wherein at least one DAV of the plurality of DAVs is based on at least one predicted DAV.

5. The method of claim 1, wherein:
the NTN includes resources to perform the plurality of processing actions; and
at least one DAV of the plurality of DAVs is based on a demand on the resources for performing respective at least one processing action of the plurality of processing actions.

6. The method of claim 5, wherein the demand on the resources has associated thereto a schedule scheduling when an individual processing action is to be performed by the resources and at least one of the at least one DAV of the plurality of DAVs depends on the schedule.

7. The method of claim 4, wherein:
the at least one predicted DAV has associated thereto at least one statistical distribution; and
each of the at least one predicted DAV includes at least one statistical parameter of a respective one of the at least one statistical distribution.

8. The method of claim 7, wherein the at least one statistical parameter includes at least one of an expected value, a median value, an average value, and a maximum value.

9. The method of claim 1, further comprising:
obtaining a position of the NTN relative to the TN;
determining, in accordance with the position of the NTN relative to the TN, a time-of-flight delay value for the TCM to reach the TN; and
adding the time-of-flight delay value to the total DAV to obtain the adjusted timestamp.

10. The method of claim 9, further comprising:
obtaining a frequency shift associated with a Doppler effect caused by a relative speed between the NTN and the TN;
obtaining, in accordance with the frequency shift and the time-of-flight delay value, a Doppler DAV; and
adding the Doppler DAV to the total DAV to obtain the adjusted timestamp.

11. The method of claim 1, further comprising:
obtaining the plurality of DAVs; and
performing each processing action of the plurality of processing actions within a respective time period defined by the respective DAV of the plurality of DAVs.

12. The method of claim 1, wherein the plurality of processing actions include user datagram protocol (UDP) actions configured to form a UDP packet comprising the adjusted timestamp.

13. The method of claim 12, wherein the plurality of processing actions further include forming a packet data convergence protocol (PDCP) packet comprising the UDP packet.

14. The method of claim 13, wherein the plurality of processing actions further include forming a radio link control (RLC) packet comprising the PDCP packet.

15. The method of claim 14, wherein the plurality of processing actions further include forming one or more of: a medium access control (MAC) packet comprising the RLC packet or a physical (PHY) packet comprising the MAC packet.

16. The method of claim 9, wherein obtaining the position of the NTN relative to the TN includes obtaining the position based on a predetermined position at an initial time, on a predetermined position rate of change as a function of time, and on a time period passed since the initial time.

17. The method of claim 1, wherein:
the communication network comprises a plurality of nodes, including the TN;
resources configured to perform the method are also configured to process and transmit other messages from the NTN to any node of the plurality of nodes;
parameters of the resources include, for at least one message of the other messages, at least one of:
a bit rate,
a symbol duration,
a number of bits per symbol, or
a modulation format.

18. A method at a terrestrial node (TN) that has a target clock, the method comprising:
receiving, from a non-terrestrial node (NTN), a timestamp-carrying message (TCM) generated at the NTN, the TN being part of a communication network, the communication network comprising the NTN that is coupled to a reference clock, the TCM comprising an adjusted timestamp, the NTN being configured to generate the TCM by performing a plurality of processing actions having associated thereto a plurality of delay adjustment values (DAVs), each processing action of the plurality of processing actions being associated with a respective DAV of the plurality of DAVs, the plurality of processing actions including:
computing a sum of the plurality of DAVs to obtain a total DAV;
adding the total DAV to an original timestamp to obtain the adjusted timestamp,
wherein the original timestamp is obtained based on the reference clock; and
encapsulating the adjusted timestamp to form the TCM;
de-encapsulating the TCM to obtain the adjusted timestamp, the adjusted timestamp being a time T1, a time at which the TCM is received at the TN being a time T2;
transmitting, at a time T3, a TN message to the NTN;
receiving, from the NTN, a NTN message containing a time T4, wherein the time T4 being the time at which the TN message is received at the NTN; and
in accordance with the time T1, the time T2, the time T3 and the time T4, adjusting the target clock.

19. A method at a non-terrestrial node (NTN) coupled to a reference clock, the method comprising:
obtaining an original timestamp based on the reference clock;
generating a plurality of corrected timestamps in accordance with:
a plurality of processing delay values (PDVs), each PDV of the plurality of PDVs being associated with a respective processing action of a plurality of processing actions to be performed to generate a timestamp-carrying packet; and
a plurality of different time increments, each corrected timestamp of the plurality of corrected timestamps having a value that includes a sum of the plurality of PDVs and one different time increment of the plurality of different time increments;
generating a plurality of timestamp-carrying packets, each timestamp-carrying packet of the plurality of timestamp-carrying packets comprising a respective different corrected timestamp of the plurality of corrected timestamps;
determining a transmission time to transmit, to a terrestrial node (TN), one of the plurality of timestamp-carrying packets, wherein the NTN is part of a communication network, the communication network further comprises the TN that comprises a target clock;
identifying, to obtain an identified timestamp-carrying packet, which of the plurality of timestamp-carrying packets has an adjusted timestamp closest to the transmission time; and
transmitting, to the TN, the identified timestamp-carrying packet.

20. The method of claim 19, further comprising:
encapsulating the identified timestamp-carrying packet to obtain an encapsulated timestamp-carrying packet; and
transmitting the encapsulated timestamp-carrying packet to the TN.
